(19) United States
(12) Patent Application Publication
(10) Pub. No.: US 2020/0376356 A1
(43) Pub. Date: Dec. 3, 2020

(54) IMPROVEMENT FOR AN ILLUMINATED SPORTS NET

(71) Applicants: Wagner de Amorim CARDOSO, Campo Grande City Santos - SP (BR); Maria Luiza Paes De BARROS, City São Paulo - SP (BR)

(72) Inventors: Wagner de Amorim CARDOSO, Campo Grande City Santos - SP (BR); Maria Luiza Paes De BARROS, City São Paulo - SP (BR)

(21) Appl. No.: 16/955,074

(22) PCT Filed: Dec. 14, 2018
(86) PCT No.: PCT/BR2018/050464

§ 371 Date: Jun. 18, 2020

(30) Foreign Application Priority Data
Dec. 18, 2017 (BR) BR 202017 027372

(51) Int. Cl. A63B 63/00; G09F 9/33; G09F 23/00; F21V 15/01

(52) U.S. Cl. CPC A63B 63/00; G09F 9/33; F21Y 2115/10; F21V 15/01; A63B 2225/74; G09F 23/0066

(57) ABSTRACT

The following present utility model patent application comprises a set of side strips (20) and support strips (25), protection bands (23) connected to a box (2) and lid (17) for receiving LEDs (L) that, when assembled, form an illuminated sports net that can generate images, preferably inside the goal (G), having high strength against impact and traction, caused both by the impact of the ball on the net or by the impact of the player, resulting from the player's speed in their desire to score points.

Follows this application for a utility model patent, formed by a set of strips connected to a box with a lid and pins, accommodating LEDs, which, when assembled, will form a luminous sports net capable of generating images, preferably inside of the goal, with great resistance to impact and traction, either by the incidence of the ball in the net or by the player's own incidence, due to their speed in the desire to score points.

### STATE OF THE ART

As it is known, more specifically football is a type of sport that attracts the focus of a large audience. In addition, advertisements release becomes extremely valuable in these environments. In this sense, we can refers to the document “BR 10 2015 002247-6”, “LUMINOUS MEDIA APPLIED TO SPORT NET, FOR THE ADVERTISEMENT RELEASE SYSTEM”, constituted from a luminous media formed by a frame/mesh—optical fibre, e-textile, e-knitting, yarn/electroluminescent fibre, etc. or preferably LED strips, arranged for orderly lighting to reproduce a certain logo, advertising message, information or similar. The media receives a communicating receiver with a processor. After being fixed by a loop, interlacing or other common means of connecting the mesh surface of the sport net, the media is maintained so that the luminosity is strategically directed to the public's view. In this state, the processor, with its logical programming duly defined, is fixed at a point that allows communication by radio frequency with the receiver of the luminous media so that, when the punctuation is made, the processor emits the signal that is received and read by the light media receiver. This, in turn, reproduces the luminosity by turning on the LEDs, arranged neatly in order to form the image of the logo to be conveyed. In this way, an effective means of disseminating a plurality of advertisements is guaranteed, taking advantage of a fundamental point, which is the sports net to disseminate the sports message in football, tennis, volleyball matches, etc. through the LEDs and in gyms, arenas, stadiums, etc.

This media, because it is a system aggregated to the conventional nets, suffers great damages due to the impacts caused by the incidence of the ball in the net inside the goal and with that end up compromising (breaking) the whole electronic part, such as cables and welds that form the luminous weave making its application not so efficient, in addition to not complying with the legal criteria that govern these sports, one of which is the prohibition of aggregates in the nets that make up the goal.

In order to solve such problems, the same inventor developed and requested an “IMPROVEMENT IN THE SPORT NET” number BR 202017 015643 0, which provides a weave formed by strips of fabric, which when crossed receive stitches forming a fabric capable of wrapping the LED power cables with velcro, which, in turn, remains exposed.

It turns out that such improvement does not effectively provide a perfect shielding of the LEDs, not even of their power cables, where all electronics are extremely vulnerable to impacts and pulls by the players.

### OBJECTIVE OF THE PATENT

It was due to such inconvenience that the inventor requests a utility model order, formed by a set of box-cover strips and pins to accommodate LEDs that, when assembled, will form a luminous sport net capable of generating images preferably inside the goal, with great resistance to impact and traction, be it due to the incidence of the ball in the net or the incidence of the player, due to their speed to score points.

Explained superficially, this request is better detailed according to the attached drawings, showing:

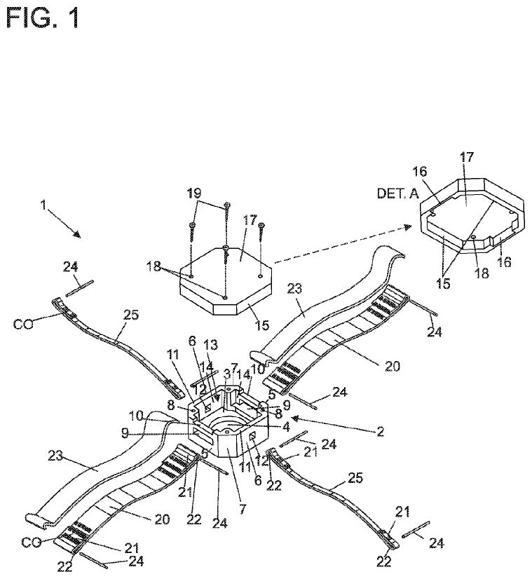

FIG. 1—exploded view of the set. In this view we can see the box with its strips aligned to its cutouts, as well as the protective strips aligned to their respective lateral strips and the lid aligned to the edge of the box, whereas the lid is represented below by the detail “A”;

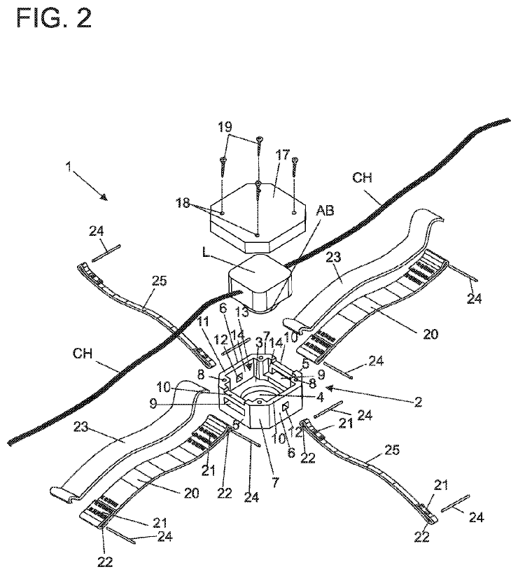

FIG. 2—view according to the previous figure with the LED and its electrical harness aligned to the box and the lateral strips;

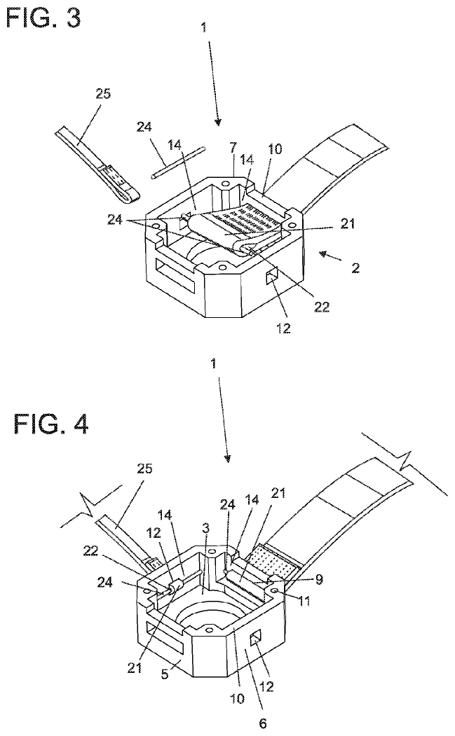

FIG. 3—schematic view showing the introduction of the terminal of the lateral strip inserted in the through cutout, while a pin was inserted in this eyelet;

FIG. 4—representative view of what will happen with the other strips. For this, the ends of the lateral strip and the support strips anchored by their pins on the back walls in their respective cutouts.

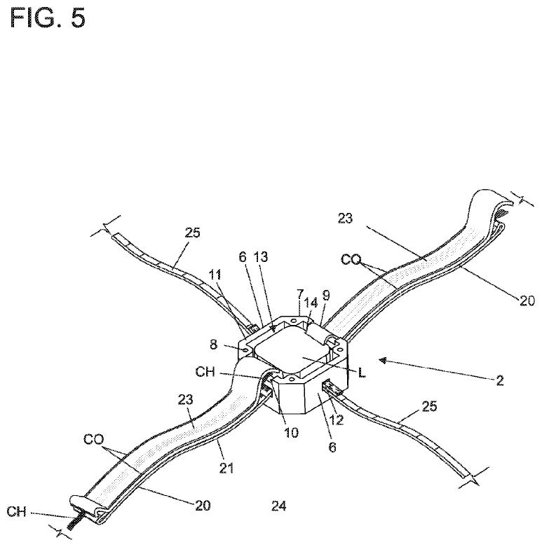

FIG. 5—view according to the previous figure with the LED positioned inside the box and with its harnesses seated on the lateral recesses followed by the protective strip lining sewn on the lateral strip so that the whip remains fully protected. In this state, scrap material from the protective strips form free ends that are also positioned inside the box;

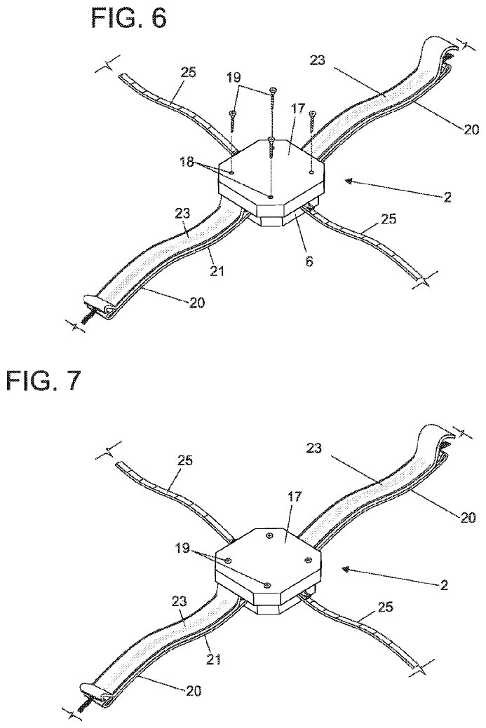

FIGS. 6 and 7—sequential view according to the previous figure with the box receiving its cover that ends up keeping the LED protected and the free ends of the protective tape followed by the screwing through its holes that coincide with the holes on the edge of the box;

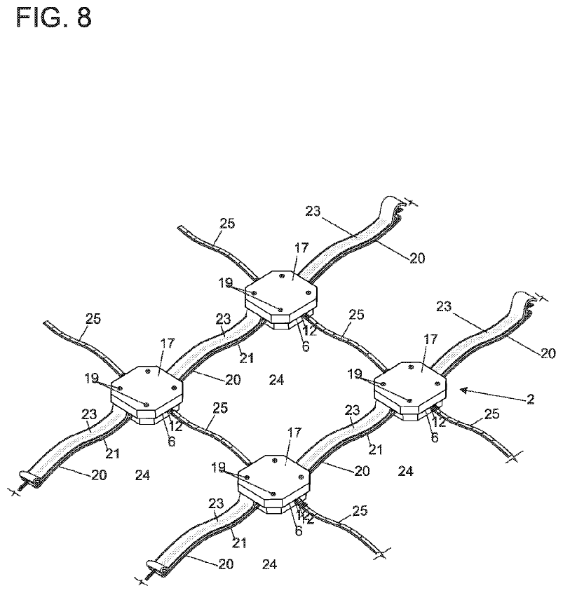

FIG. 8—view according to the previous figure with a series of units assembled sequentially forming a mesh;

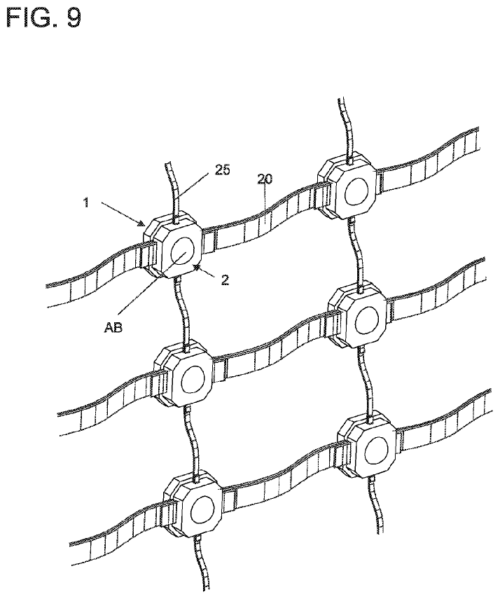

FIG. 9—view according to the previous figure of the mesh, but represented frontally, where the LED's luminous vault is exposed;

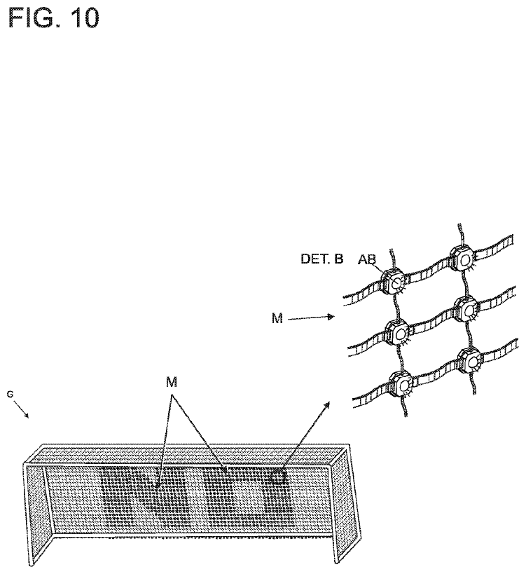

FIG. 10—view according to the previous figure of the mesh positioned on the structure of a “goal”, forming a luminous sport net highly resistant to impact, and also shown through detail B, the lit LEDs forming the pre-programmed image coming from a controller not shown.

In accordance with the attached drawings, follows the “IMPROVEMENT INTRODUCED IN THE LUMINOUS SPORT NET”, reason for this patent application for a utility model, for a set (1) formed by a box (2) with a bottom (3) with conical hole (4) surrounded by lateral walls (5) and cross walls (6), and also bevelled vertices (7) with upper holes (8). In turn, these lateral walls (5) receive pass-through cutouts (9) that align with a recess (10) of an edge (11), while the transverse walls (6) also receive very small cutouts (12) that define a cradle (13) with back walls (14).

The edge (11) is marked by flaps (15) with recesses (16) of a lid (17) with holes (18) for screws (19).

The pass-through cutouts (8) align with their respective lateral strips (20) formed by their folded and sewn ends (21) composing an eyelet (22) so that this tape (20) receives the overlap, also by stitching (CO), a protective strip (23), while its eyelets (22) coincide with pins (24). The smallest cutouts (12) receive a support strip (25) and also folds and seams (21) forming eyelets (22), but this is devoided of a protective strip (23).

Thus constituted, the set will be used to form a luminous sport net composed of LEDs. For this purpose, in its assembly, the eyelets (22) of both tapes (20) and (25) are inserted in their respective cutouts (9) and (12) so that their eyelet enters the interior of the box (2). Then the pin (24) is inserted into the eyelet (22) until it overtakes the other side allowing the strips (20) and (25) to be pulled until the pins (24) touch their respective back walls (14), and thus strongly anchoring the ends of the tapes (20) and (25) inside the box (2) as shown in FIG. 4. The same occurs at opposite ends, by introducing new boxes (2) until it forms a mesh (M).

When inserting the LEDs (L) in the cradle (13), its dome (AB) is seated under the conical hole (4) so that it is visible from the other side of the bottom (3) of the box (2), therefore, its feeding whip (CH) passes over the recess (10) and runs over the surface of the lateral strip (20) until its opposite end reaches the LED (L) housed in the following box (2). In this state, the protective strip (23) overlaps the whip (CH), followed by stitching (CO) at its edges leaving only its free ends and thus this whip (CH) is kept protected inside so that the same overlap occurs on the subsequent lateral strips (20). The box (2) is then completed by fitting the lid (17), which in turn keeps the free ends of the protective strip (23) inside the box by compensating for the space generated by the recesses (16), being then the lid (17) locked on the box (2) by inserting the screws (19) in the holes (18) and (8), and so on until all the boxes (2) that make up the mesh (M), are properly closed.

Thus constituted, the mesh (M) is then placed in the goal posts (G) so that the ends of the columns formed by the support strips (25) are anchored in the goal's rear beams (G), whereas the ends of the rows formed by the lateral strips (20) are attached to the lateral structures also at the rear of the goal (G) so that the LEDs (L) are facing the inside of the goal (G).

Such construction, allows all traction of the net to be supported on the tapes (20) and (25), which ends up guaranteeing the integrity of the harness (CH) coming from the controllers (not shown), in addition to shielding the LEDs (L) against water and wear.

1. “IMPROVEMENTS INTRODUCED IN A LUMINOUS SPORT NET”, characterised by a set (1) formed by a box (2) provided with a bottom (3) with a conical hole (4) surrounded by lateral walls (5) and transverse walls (6), and also chamfered vertices (7) with upper holes (8). In turn, these lateral walls (5) receive pass-through cutouts (9) that align with the recess (10) of an edge (11), while the transverse walls (6), receive equally tiny cutouts (12) that define a cradle (13) with back walls (14) for pins (24) wrapped by the eyelet (22) of the folded and sewn ends (21) of the support strips (25) and lateral strips (20), which in turn, the latter is provided with a protective strip (23) connected by stitching (CO) to this lateral strip (20), so that it surrounds the whip (CH) that extends to the inside of the box (2) accommodating the LED (L) and the free ends of the protective strips (23), which are maintained there by the flap overlap (15) provided with recesses (16) delimiting a lid (17) attached to the bottoms (8) by screws (19) passing through the pass-through holes (18).

2. “IMPROVEMENT INTRODUCED IN A LUMINOUS SPORT NET”, according to claim 1, characterised by the set (1) forming a luminous sports mesh (M) resistant to water and impacts.
